(19) United States
(12) Patent Application Publication
(10) Pub. No.: US 2007/0039833 A1
(43) Pub. Date: Feb. 22, 2007

(54) Method for measuring corrosion inhibitor concentration

(75) Inventors: Chih-Pen Lin, Tu-cheng (TW); Min Tian, Shenzhen (CN); Da-Wei Gu, Shenzhen (CN); Gang-Sheng Zhang, Shenzhen (CN); Shih-Yi Hong, Tu-cheng (TW)

Correspondence Address: PCE INDUSTRY, INC.;ATT. CHENG-JU CHIANG JEFFREY T. KNAPP, 458 E. LAMBERT ROAD, FULLERTON, CA, 92835, US

(73) Assignee: FIH CO., LTD, Shindian City (TW)

(21) Appl. No.: 11/453,461

(22) Filed: Jun. 14, 2006

(30) Foreign Application Priority Data
Aug. 19, 2005 (CN) 200510036748.8

(51) Int. Cl. G01N 27/26

(52) U.S. Cl. 205/775

(57) ABSTRACT

A method for measuring metal ion concentration includes the following steps of: providing a measuring solution having a corrosion inhibitor; adding a specific quantity of metal ion solution into the measuring solution; providing a potential scan device (1); measuring a cyclic voltammetry curve of the measuring solution using the potential scan device at a constant scan rate in a specific potential range, the cyclic voltammetry curve has a peak current; obtaining a linear equation, which indicates a linear relationship of peak current versus a concentration of corrosion inhibitor in standard corrosion inhibitor solution in the specific potential range, the peak current is a peak current of cyclic voltammetry curve of the specific quantity of metal ion solution metal ion in the standard corrosion inhibitor solution in the specific potential range; and determining a concentration of the corrosion inhibitor of the measuring solution by computing the peak current of the cyclic voltammetry curve of the measuring solution in linear equation.

### TECHNICAL FIELD

The present invention relates to methods for measuring corrosion inhibitor concentration and, particularly, to a method for measuring corrosion inhibitor concentration by means of cyclic voltammetry.

### BACKGROUND

Chemical polishing, metal electroplating and etching are typical technologies in surface treatment, and can be used for manufacturing decorative films, various functional films, and semiconductors. Generally, corrosion inhibitors are often used in chemical polishing, metal electroplating and etching as an additive. For example, in chemical polishing technology, corrosion inhibitor, when added in small concentration to an environment, effectively decreases the corrosion rate. However, if corrosion inhibitor is added excessively, it can result in incomplete chemical polishing and decreased polishing quality. If not enough corrosion inhibitor is added, a desired corrosion effect cannot be achieved. Therefore, it is necessary to measure and control corrosion inhibitor concentration in an electroplating bath or etching bath. Typically, a corrosion inhibitor concentration is determined based on experience, which is difficult to do when comparing corrosion inhibitor concentration in chemical polishing bath, metal electroplating bath or etch bath.

What is needed, therefore, is a method for measuring corrosion inhibitor concentration which overcomes the above-described shortcomings.

### SUMMARY

In a first preferred embodiment, a method for measuring corrosion inhibitor concentration includes the following steps of: providing a measuring solution having a corrosion inhibitor; adding a specific quantity of metal ion solution into the measuring solution; providing a potential scan device; measuring a cyclic voltammetry curve of the measuring solution using the potential scan device at a constant scan rate in a specific potential range, wherein the cyclic voltammetry curve has a peak current; obtaining a linear equation, which indicates a linear relationship of peak current versus a concentration of corrosion inhibitor in standard corrosion inhibitor solution in the specific potential range, the peak current is a peak current of cyclic voltammetry curve of the specific quantity of metal ion solution metal ion in the standard corrosion inhibitor solution in the specific potential range; and determining a concentration of the corrosion inhibitor of the measuring solution by computing the peak current of the cyclic voltammetry curve of the measuring solution in linear equation.

Other advantages and novel features will become more apparent from the following detailed description when taken in conjunction with the accompanying drawings.

### BRIEF DESCRIPTION OF THE DRAWING

Many aspects of the method for measuring corrosion inhibitor concentration can be better understood with reference to the following drawing. The components in the drawing are not necessarily drawn to scale, the emphasis instead being placed upon clearly illustrating the principles of the present method for measuring corrosion inhibitor concentration. Moreover, in the drawing, like reference numerals designate corresponding parts throughout the view.

FIG. 1 is an schematic, isometric view of a potential scan device for achieving a metal ion concentration measuring method, according to a preferred embodiment.

### DETAILED DESCRIPTION OF PREFERRED EMBODIMENTS

A corrosion inhibitor can inhibit electrode reaction of metal ions, such as copper ions, ferrous ions, and the like. In a metal ion solution reaction system having corrosion inhibitor, a concentration of the corrosion inhibitor has bear on a current density of an electrode reaction of the metal ion. The higher concentration of the corrosion inhibitor is, the more corrosion inhibitor can inhibit electrode reaction of metal ion, and the smaller the current density of an electrode reaction of the metal ion is. In this preferred embodiment, it can be found from experiments that a peak current of cyclic voltammetry curve of metal ion solution linearly depends on a concentration of corrosion inhibitor in the metal ion solution by means of cyclic voltammetry at a specific potential range.

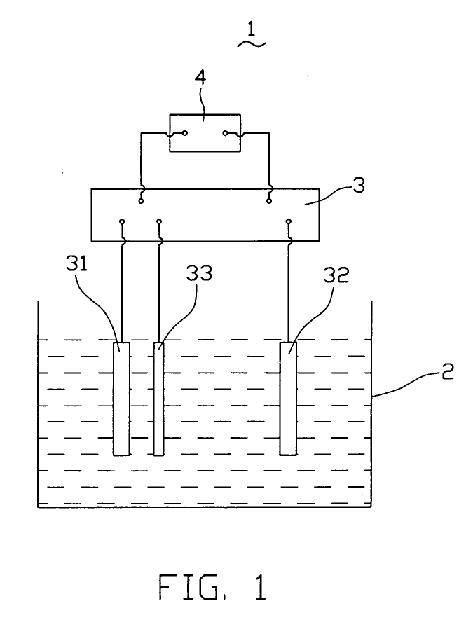

A method for measuring corrosion inhibitor concentration according to the preferred embodiment is explained by measuring a corrosion inhibitor such as a thiourea concentration in a chemical polishing bath. In this embodiment, a thiourea solution in a chemical polishing bath is provided to explain the method. Referring to FIG. 1, the method for measuring corrosion inhibitor concentration includes the following steps of:
(1) providing a measuring solution having the thiourea;
(2) adding a specific quantity of metal ion solution into the measuring solution;
(3) providing a potential scan device 1;
(4) obtaining a cyclic voltammetry curve of the measuring solution using the potential scan device 1 at a constant scan rate in a specific potential range, the cyclic voltammetry curve has a peak current (Iₚ);
(5) obtaining a linear equation, which indicates a linear relationship of current versus concentration of thiourea in standard corrosion inhibitor solution having the metal ion, the current is a peak current of cyclic voltammetry curve of metal ion in the standard corrosion inhibitor solutions in the specific potential range; and
(6) determining a concentration of the thiourea of the measuring solution by computing the peak current of the cyclic voltammetry curve of the measuring solution in linear equation.

In step one, a predetermined solution having the thiourea in chemical polishing bath is provided. The solution is diluted one thousand times. One hundred milliliter (ml) diluted solution is provided and saved to be used as the measuring solution.

In step two, the potential scan device 1 includes a container 2, a potentiostat 3, a potential-current recorder 4. The potentiostat 3 includes a working electrode 31, an auxiliary electrode 32, and a reference electrode 33. The potential-current recorder 4 is electrically connected with the potentiostat 3. The working electrode 31 is glass carbon electrode. The auxiliary electrode 32 is platinum electrode. The reference electrode 33 is silver/silver-chloride. The potential-current recorder 4 records current value and potential value of the working electrode 31 simultaneously.

In step three, the measuring solution is placed in the container 2. Two drops of a copper ion solution having a concentration of 1 mol/l are titrated into the container 2. At the same time, acidic or alkaline solution is titrated into the container 2. A PH value of the measuring solution in the container 2 is detected, and maintained at PH value in the range from 3.0 to 4.0, preferably 3.7. The working electrode 31, the auxiliary electrode 32, and the reference electrode 33 are immersed into the container 2. The potential scan device 1 scans cyclic voltammetry measuring solution in the container 2. The potential range of potentiostat 3 is initiated in the range from 0.4 to −0.4 volts, and a potential scan rate is maintained at 0.1 volts/s. The potentiostat 3 scans in the range from 0.4 to −0.4 volts and at a scan rate of 0.1 volts/s by means of cyclic voltammetry. The potential is measured between the reference electrode 33 and the working electrode 31 and the current is measured between the working electrode 31 and the auxiliary electrode 32. The potential and the current is recorded by the potential-current recorder 4. The data including the potential and the current is then plotted as potential (E) versus current (I) by the potential-current recorder 4. In this embodiment, there produces a current peak (Iₚ) when the potential of the working electrode 31 is in the range from 0.4 to −0.4 volts.

In step four, a plurality of 100 ml standard thiourea solutions, in which thiourea concentration is known, are provided. The thiourea concentration of different standard corrosion inhibitor solutions is varied. Two drops of copper ion solution having a concentration of 1 mol/l are also titrated into each standard thiourea solution. Each drop of the copper ion solution has a volume of 0.05 ml. Thus, a concentration of the copper ion in the standard thiourea solution is 0.001 mol/l. Also, a PH value of each standard thiourea solutions is controlled to be same as that of the measuring solution. The potential scan device 1 scans each standard thiourea solutions in the potential range from 0.4 to −0.4 volts and at a scan rate of 0.1 volts/s by means of cyclic voltammetry to obtain a peak current corresponding to the standard thiourea solutions, as shown in the following table 1 to table 5. Using the peak currents for the plurality of standard thiourea solutions, a calibration curve of peak current versus thiourea concentration is constructed. It can be found that thiourea concentration has a linear relationship with the peak current according to peak current corresponding to the standard thiourea solutions. Thus, a linear equation is obtained base on the thiourea concentration and the corresponding peak current.

In step five, a thiourea concentration value of the measuring solution is determined by computing the peak current relating to the measuring solution in the linear equation. The thiourea concentration value is multiplied by 1000. Therefore, a thiourea concentration in the electroplating chemical polishing bath can be obtained.

Tables 1-5 show experiment records for testing repeatability, accuracy, and effect of interfering ions of the present method. Table 1 shows four groups of peak current values, corresponding to three kinds of standard thiourea solutions, in which thiourea concentration are 0 mg/l, 7 mg/l, 14 mg/l, and 28 mg/l respectively and copper ion concentration is 0.001 mol/l. Each group of peak current values includes five peak current values, corresponding to five measuring sample of each kind of standard thiourea solution.

TABLE 1

| Corrosion inhibitor | Peak current Iₚ (milliampere(mA)) | | | | |
|---|---|---|---|---|---|
| concentration (mg/l) | 1 | 2 | 3 | 4 | 5 |
| 0 | −9.80 × 10⁻⁵ | −9.57 × 10⁻⁵ | −9.19 × 10⁻⁵ | −1.04 × 10⁻⁵ | −9.48 × 10⁻⁵ |
| 7 | −7.95 × 10⁻⁵ | −7.98 × 10⁻⁵ | −7.88 × 10⁻⁵ | −7.65 × 10⁻⁵ | −7.70 × 10⁻⁵ |
| 14 | −5.95 × 10⁻⁵ | −6.38 × 10⁻⁵ | −6.34 × 10⁻⁵ | −5.68 × 10⁻⁵ | −6.22 × 10⁻⁵ |
| 28 | −3.57 × 10⁻⁵ | −3.58 × 10⁻⁵ | −3.67 × 10⁻⁵ | −3.53 × 10⁻⁵ | −3.65 × 10⁻⁵ |

Table 2 shows three groups of peak current values, corresponding to three kinds of reference copper ion solution, in which copper ion concentration is 0.001 mol/l and no corrosion concentration is added. However, each reference copper ion solution includes other interference ion, in which aluminum ion (Al³⁺) concentrations are 1 mg/l, 5 mg/l, and 10 mg/l. Each groups of peak current values includes five peak current values, corresponding to five measuring sample of each kind of reference copper ion solution.

TABLE 2

| Al³⁺ ion | Peak current Iₚ (mA) | | | | |
|---|---|---|---|---|---|
| concentration (mg/l) | 1 | 2 | 3 | 4 | 5 |
| 1 | −1.08 × 10⁻⁵ | −9.77 × 10⁻⁵ | −1.04 × 10⁻⁵ | −1.04 × 10⁻⁵ | −9.56 × 10⁻⁵ |
| 5 | −1.03 × 10⁻⁵ | −9.83 × 10⁻⁵ | −1.04 × 10⁻⁵ | −1.01 × 10⁻⁵ | −9.65 × 10⁻⁵ |
| 10 | −1.01 × 10⁻⁵ | −9.86 × 10⁻⁵ | −9.66 × 10⁻⁵ | −1.03 × 10⁻⁵ | −9.76 × 10⁻⁵ |

Table 3 shows one group of peak current values, corresponding to one kind of standard thiourea solution, in which aluminum ion is added. The thiourea concentration is 14 mg/l. The aluminum ion concentration is 1 mg/l. The group of peak current values includes five peak current values, corresponding to five measuring sample of the kind of standard thiourea solution.

TABLE 3

| Aluminum ion | Peak current Iₚ (mA) | | | | |
|---|---|---|---|---|---|
| concentration (mg/l) | 1 | 2 | 3 | 4 | 5 |
| 1 | −6.32 × 10⁻⁵ | −6.56 × 10⁻⁵ | −6.23 × 10⁻⁵ | −5.54 × 10⁻⁵ | −5.84 × 10⁻⁵ |

Table 4 shows three groups of peak current values, corresponding to three kinds of reference copper ion solution, in which no corrosion concentration is added. However, each standard corrosion inhibitor solution includes phosphate ion (PO₄³⁻), in which phosphate ion concentrations are 100 mg/l, 500 mg/l, and 1 g/l. Each groups of peak current values includes five peak current values, corresponding to five measuring samples of each kind of standard corrosion inhibitor solution.

TABLE 4

| PO₄³⁻ ion | Peak current Iₚ (mA) | | | | |
|---|---|---|---|---|---|
| concentration (mg/l) | 1 | 2 | 3 | 4 | 5 |
| 100 | −9.85 × 10⁻⁵ | −9.64 × 10⁻⁵ | −1.01 × 10⁻⁵ | −9.76 × 10⁻⁵ | −9.69 × 10⁻⁵ |
| 500 | −1.04 × 10⁻⁵ | −9.95 × 10⁻⁵ | −1.00 × 10⁻⁵ | −9.94 × 10⁻⁵ | −9.86 × 10⁻⁵ |
| 1000 | −9.88 × 10⁻⁵ | −9.94 × 10⁻⁵ | 9.83 × 10⁻⁵ | −1.02 × 10⁻⁵ | −4.80 × 10⁻⁵ |

Table 5 shows one group of peak current values, corresponding to one kind of standard thiourea solution, in which phosphate ion is added. The standard thiourea solution concentration is 14 mg/l. The phosphate ion concentration is 1 mg/l. The group of peak current values includes five peak current values, corresponding to five measuring samples of the kind of reference copper ion solution.

TABLE 5

| PO₄³⁻ ion | Peak current Iₚ (mA) | | | | |
|---|---|---|---|---|---|
| concentration (mg/l) | 1 | 2 | 3 | 4 | 5 |
| 1000 | −6.33 × 10⁻⁵ | −6.23 × 10⁻⁵ | −5.95 × 10⁻⁵ | −6.14 × 10⁻⁵ | −6.31 × 10⁻⁵ |

It can be seen from table 1 that a mean deviation of all peak currents is equal to or less than 3.4%. Comparing peak current shown in table 1, table 3, and table 5, fractional error of peak current of the standard thiourea solution including Al³⁺, PO₄³⁻ is equal to or less than 4.3%. The method for measuring metal ion concentration is easily operated, and has high accuracy.

It is to be understood, however, that even though numerous characteristics and advantages of the present embodiments have been set forth in the foregoing description, together with details of the structures and functions of the embodiments, the disclosure is illustrative only, and changes may be made in detail, especially in matters of shape, size, and arrangement of parts within the principles of the invention to the full extent indicated by the broad general meaning of the terms in which the appended claims are expressed.

What is claimed is:

1. A method for measuring corrosion inhibitor concentration comprising the steps of:
providing a measuring solution having a corrosion inhibitor;
adding a specific quantity of metal ion solution into the measuring solution;
providing a potential scan device;
measuring a cyclic voltammetry curve of the measuring solution using the potential scan device at a constant scan rate in a specific potential range, the cyclic voltammetry curve has a peak current;
obtaining a linear equation, which indicates a linear relationship of peak current versus a concentration of corrosion inhibitor in standard corrosion inhibitor solution in the specific potential range, the peak current is a peak current of cyclic voltammetry curve of the specific quantity of metal ion solution metal ion in the standard corrosion inhibitor solution in the specific potential range; and
determining a concentration of the corrosion inhibitor of the measuring solution by computing the peak current of the cyclic voltammetry curve of the measuring solution in linear equation.

2. The method for measuring corrosion inhibitor concentration as claimed in claim 1, wherein a determination of the linear equation comprises the steps of: providing a plurality of groups of standard corrosion inhibitor solutions, in which the corrosion inhibitor concentration is known; providing a plurality of groups of the specific quantity of metal ion solutions; adding the specific quantity of metal ion solution into a corresponding standard corrosion inhibitor solution; measuring a cyclic voltammetry curve of each group of standard corrosion inhibitor solution using the potential scan device at the constant scan rate in the specific potential range, the cyclic voltammetry curve having a peak current; determining the linear equation base on the corrosion inhibitor concentration of the standard corrosion inhibitor solution and the corresponding peak current.

3. The method for measuring corrosion inhibitor concentration as claimed in claim 2, wherein the metal ion is selected from the groups consisting of nickel ion, copper ion, chromic ion, and ferrous ion.

4. The method for measuring corrosion inhibitor concentration as claimed in claim 2, wherein metal ion is copper ion.

5. The method for measuring corrosion inhibitor concentration as claimed in claim 4, wherein the concentration of the metal ion is 0.001 mol/l.

6. The method for measuring corrosion inhibitor concentration as claimed in claim 1, wherein a PH value of the measuring solution and the reference metal ion solutions is in the range from 3.0 to 4.0.

7. The method for measuring corrosion inhibitor concentration as claimed in claim 1, wherein the constant scan rate is 0.1 volts/s.

8. The method for measuring corrosion inhibitor concentration as claimed in claim 1, wherein the specific potential range is from 0.4 to −0.4 volts.

9. The method for measuring corrosion inhibitor concentration as claimed in claim 1, wherein the potential scan device includes a potentiostat, and a potential-current recorder electrically connected with the potentiostat.

10. The method for measuring corrosion inhibitor concentration as claimed in claim 9, wherein the potentiostac includes a working electrode, auxiliary electrode, and a reference electrode.

11. The method for measuring corrosion inhibitor concentration as claimed in claim 10, wherein the working electrode is glass carbon electrode, the auxiliary electrode is platinum electrode, the reference electrode is silver-chloride.
